(19) United States
(12) Patent Application Publication
(10) Pub. No.: US 2015/0146199 A1
(43) Pub. Date: May 28, 2015

(54) DEVICE AND METHOD FOR DETERMINING THE PRESENCE OF DAMAGE OR DIRT IN A DOPPLER LASER ANEMOMETRY PROBE PORTHOLE

(71) Applicant: THALES, Neuilly-Sur-Seine (FR)

(72) Inventors: Philippe Rondeau, Allex (FR); Jean-Pierre Schlotterbeck, Rochefort-Samson (FR); Xavier Lacondemine, Valence (FR)

(21) Appl. No.: 14/546,203

(22) Filed: Nov. 18, 2014

(30) Foreign Application Priority Data
Nov. 22, 2013 (FR) 1302694

(51) Int. Cl. G01N 21/88; G01M 11/02; G01N 21/25

(52) U.S. Cl. CPC G01N 21/88; G01N 21/255; G01M 11/02; G01N 2201/10; G01N 2201/08
USPC 356/237.3

(57) ABSTRACT

A device for determining the presence of damage or dirt on a Doppler laser anemometry probe (2) porthole (1) comprising means (6) for implementing a continuous angular scan of the laser beam, means (7) for determining a current spectral component of the output signal of the probe (2) corresponding to a parasitic signal due to parasitic reflections on the path common to the emitted wave and the wave backscattered by the medium during spectral analysis of the anemometric signal, and means (8) for comparing said current spectral component of the current parasitic signal with a reference spectral component of the reference parasitic signal.

### BACKGROUND OF THE INVENTION

1. Field of the Invention

The present invention relates to a device and method for determining the presence of damage or dirt on a Doppler laser anemometry probe porthole.

2. Description of Related Art

Anemometric systems, particularly for aircraft, are based on measurements of total pressure (Pitot probes) and static pressure, combined with temperature measurements. It is however desirable to possess a dissimilar means for measuring the speed of an aircraft in relation to the surrounding air, commonly called air speed, capable of functioning correctly at low speeds.

A measuring device of anemometric LiDAR type, an acronym of “light detection and ranging”, or, in other words, a Doppler laser anemometry probe, is considered to be an alternative and totally dissimilar measuring means making it possible to acquire a measurement of the air speed, including at low speeds.

Deterioration of the Doppler laser anemometry measurement performance can originate in the presence of damage or dirt on the porthole that makes it possible to transmit the laser beam in the mass of air whose relative speed with respect to the aircraft one wishes to measure.

This damage of the porthole results in two undesirable effects. The first effect is the deterioration of the beam transmitted in the air mass as much in terms of optical quality as in terms of power level. This has the consequence of reducing the power of the received Doppler laser anemometry signal. The second effect is to create a parasitic “Narcissus” echo that increases the noise level of the system. The dirt, scratches or other damage indeed produce a set of sources of scattering of the beam and part of the scattered beam is then collected by the system to produce this Narcissus echo. These two effects imply a deterioration of the signal-to-noise ratio of the measurement, reducing the sensitivity of the system and the accuracy of measurement. The amplitude of this Narcissus echo being generally very much higher than that of the signal enabling the measurement to be made, cut-off filters are generally implemented so as to avoid any saturation of the measurement chains. For a system intended for aeronautical use, with the associated robustness constraints, it is therefore necessary to be able to detect such deterioration and to evaluate its severity in IBIT (Initiated Built-In Test) or CBIT (Continuous Built-In Test) processes in order to guarantee the availability of the measurement.

In the absence of a system for automatically detecting damage or dirt on a Doppler laser anemometry probe porthole, only the regular maintenance of such probes makes it possible to ensure their correct operation.

### SUMMARY OF THE INVENTION

One aim of the invention is to remedy the aforementioned problems, and notably to provide, at low cost, an automatic device for detecting the presence of damage or dirt on a Doppler laser anemometry probe porthole. The invention is applicable to any type of Doppler laser anemometry probe, and particularly to those of aircraft.

According to an aspect of the invention, a device is proposed for determining the presence of damage or dirt on a Doppler laser anemometry probe porthole comprising means for implementing a continuous angular scan of the laser beam, means for determining a current spectral component of the output signal of the probe corresponding to a parasitic signal due to parasitic reflections on the path common to the emitted wave and the wave backscattered by the medium during spectral analysis of the anemometric signal, and means for comparing said current spectral component of the current parasitic signal with a reference spectral component of the reference parasitic signal. The continuous angular scan can be conical.

Such a device makes it possible to automatically determine the presence of damage or dirt on a Doppler laser anemometry probe porthole at low cost, and thus to alert the user systems or directly alert the pilot, who can then take the necessary measures. Where applicable, the pilot may base his judgment on other measurement systems, and request maintenance work on the probe porthole as soon as possible.

In an embodiment, said comparing means are suitable for computing the absolute value of the difference between the amplitude of said current component and the amplitude of said reference component and for comparing said difference with a threshold.

Thus, it is easy to determine the presence of damage or dirt on a Doppler laser anemometry probe porthole.

For example, said threshold is between 0.5 dB and 20 dB, and said threshold preferably is between 3 dB and 5 dB.

Such threshold values between 0.5 dB and 20 dB make it possible to limit the false alarm rate and to limit possible deterioration in the quality of measurement before the warning of the pilot. A threshold value between 3 dB and 5 dB corresponds to a good compromise between false alarm rates and non-detection rates.

According to another aspect of the invention, an aircraft is also proposed equipped with a device, as previously described, for determining the presence of damage or dirt on a Doppler laser anemometry probe porthole embedded on said aircraft.

According to another aspect of the invention, a method is proposed for determining the presence of damage or dirt on a Doppler laser anemometry probe porthole comprising the steps consisting in carrying out a continuous angular scan of the laser beam, determining a current spectral component of the output signal of the probe corresponding to a parasitic signal due to parasitic reflections on the path common to the emitted wave and the wave backscattered by the medium during spectral analysis of the anemometric signal, and comparing said current spectral component of the current parasitic signal with a reference spectral component of the reference parasitic signal.

The invention will be better understood on consulting a few embodiments, described by way of non-limiting example and illustrated by the appended drawings wherein:

FIG. 1 illustrates a device for determining the presence of damage or dirt on a Doppler laser anemometry probe porthole according to one aspect of the invention.

In all the figures, elements with the same references are similar.

### BRIEF DESCRIPTION OF THE DRAWINGS

FIG. 1 is a schematic illustration of a device for determining the presence of damage or dirt on a Doppler laser anemometry probe 2 porthole 1.

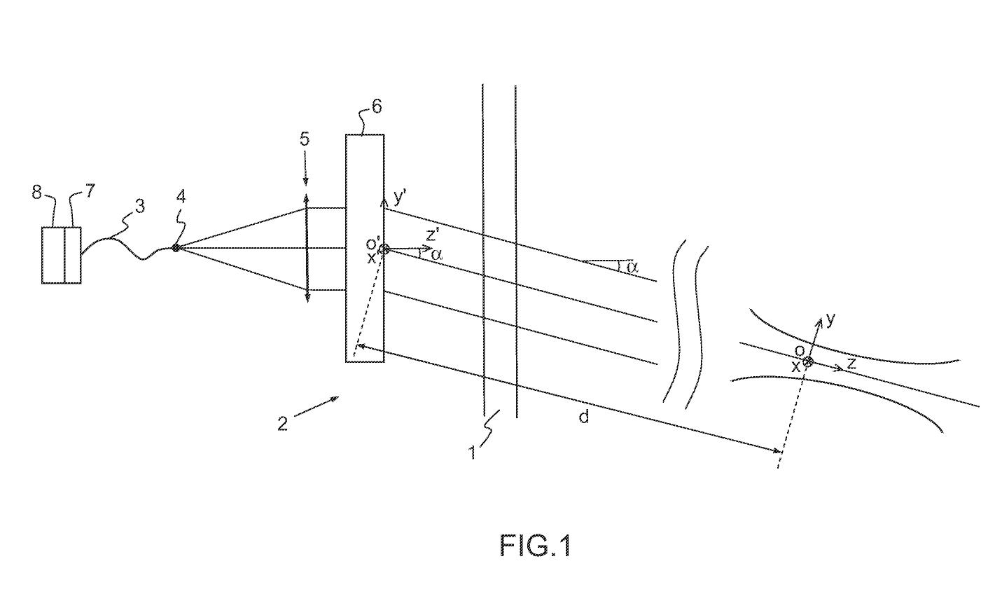

### DETAILED DESCRIPTION OF THE INVENTION

The probe comprises an optical fiber 3, a source point 4 at the end of the optical fiber 3, an optic 5 for shaping the laser beam, and a module 6 for implementing a continuous angular scan of the laser beam, in this case a continuous conical scan.

The device also comprises a module 7 for determining a current spectral component of the output signal of the probe corresponding to a parasitic signal due to parasitic reflections on the path common to the emitted wave and the wave backscattered by the medium during spectral analysis of the anemometric signal, and a module 8 for comparing said current spectral component of the current parasitic signal with a reference spectral component of the reference parasitic signal.

The comparing module 8 is suitable for computing the absolute value of the difference between the amplitude of the current component and the amplitude of the reference component and for comparing said difference with a threshold between 0.5 dB and 20 dB, and for example between 3 dB and 5 dB.

A threshold between 0.5 dB and 20 dB makes it possible to limit the false alarm rate and to limit possible deterioration of the quality of measurement before the warning of the pilot. A threshold between 3 dB and 5 dB corresponds to a good compromise between the false alarm rate and the non-detection rate.

The device according to the invention is particularly suitable for being embedded on board an aircraft, making it possible to detect the presence of damage or dirt on a Doppler laser anemometry probe porthole.

Below is a more detailed explanation of an example of the invention, wherein the beam is focused at a distance d of 25 m with a radius of curvature of the wavefronts on the exit face of the porthole of about 26 m. The difference between the focusing distance and the radius of curvature of the beam is explained by the modeling of the Gaussian beam and the choice of the associated Rayleigh length Zᵣ chosen to be equal to 5 m. The radius of curvature of the wavefront at a distance x from the focusing point or “waist” is expressed as R(x)=x+Zᵣ²/x² hence the result with x=5 m. The scanning cone has a vertex aperture half-angle α of 35° and a frequency f of rotation of 10 Hz.

Thus the position of the center of curvature

C(t) of the wavefronts at the output of the optical system is given by the following relationship:

$$C ( t ) = ( \begin{matrix}d \cdot sin α \cdot cos ( 2 π ft ) \\ d \cdot sin α \cdot sin ( 2 π ft ) \\ d \cdot cos α\end{matrix} ) \qquad ( 1 )$$

To simplify the notation, it is possible to write A=d·sin α≈14.34 m. If a scattering point P is considered on one of the faces of the exit porthole of the optical head, these coordinates are:

$$P = ( \begin{matrix}{x}^{′} \\ {y}^{′} \\ {z}^{′}\end{matrix} ) \qquad ( 2 )$$

With z′ between 3 mm and 13 mm.

O′, x′, y′ and z′ respectively represent the vertex of the scanning cone and the coordinates of the point under consideration in the reference frame with origin O′ and whose axis O′z′ is merged with the axis of the cone.

The distance between the scattering point P and the center of curvature of the wavefronts generated is therefore:

$$PC ( t ) = \sqrt{\begin{matrix}\begin{matrix}{( d \cdot sin α \cdot cos ( 2 π ft ) - {x}^{′} )}^{2} + \\ {( d \cdot sin α \cdot sin ( 2 π ft ) - {y}^{′} )}^{2} +\end{matrix} \\ {( d \cdot cos α - {z}^{′} )}^{2}\end{matrix}} \qquad ( 3 )$$

The relative speed of the scattering point P with respect to the beam therefore has a value of:

$$\frac{d PC ( t )}{d t} = 2 π f \cdot d \cdot sin α \cdot \frac{\begin{matrix}{x}^{′} \cdot sin ( 2 π ft ) - \\ {y}^{′} \cdot cos ( 2 π ft )\end{matrix}}{\sqrt{\begin{matrix}\begin{matrix}{( d \cdot sin α \cdot cos ( 2 π ft ) - {x}^{′} )}^{2} + \\ {( d \cdot sin α \cdot sin ( 2 π ft ) - {y}^{′} )}^{2} +\end{matrix} \\ {( d \cdot cos α - {z}^{′} )}^{2}\end{matrix}}} \qquad ( 4 )$$

The denominator term only varying in the second order, if the scattering point P is close to the vertex of the cone, it is possible to make the approximation that it is constant and equal to d.

This gives:

$$\frac{d PC ( t )}{d t} \approx sin α \cdot 2 π f \cdot ( {x}^{′} \cdot sin ( 2 π ft ) - {y}^{′} \cdot cos ( 2 π ft ) ) \qquad ( 5 )$$

For a point located at y′=0.01 m and x′=0 m at the instant t=0 s, a relative speed of 0.36 m/s is thus obtained, i.e. a Doppler frequency of 450 kHz.

The following is a more detailed description of the conditions that apply:

The wavelength λ of the laser beam has a value of 1.55 μm, and the radius of curvature of the wavefront of the beam on the exit face of the porthole d=26 m. The Rayleigh length Z_{R} of the illuminating beam has a value of 5 m, the thickness e of the porthole has a value of 10 mm, the aperture half-angle α at the vertex of the scanning cone has a value of 35°, and the frequency of rotation f has a value of 5 Hz.

Note that there is a lateral shift of the beam between the inner face and the outer face of the porthole 1. Thus, the two faces of the porthole 1 are located at z′=7.42 mm and z′=13.32 mm respectively from the vertex of the cone described by the axis of the beam lighting them.

The values of d and Z_{R} lead to a waist 25 m distant from the outer face of the porthole 1. In order to simplify the calculations, it is simply considered that the focusing point or “waist” is located at a distance d_{w} of 25 m from the vertex of the cone for both faces of the porthole 1.

The heterodyne current iₕₑₜ produced by a fixed particle in a monostatic LiDAR can be defined by the following relationship:

$${i}_{het} ( t ) = 4 ρ \cdot \sqrt{{P}_{OL} \cdot {P}_{IL}} \cdot \frac{λ}{π} \cdot \sqrt{σ} \cdot \frac{{e}^{- 2 \frac{{x}^{2} + {y}^{2}}{{ω}^{2} ( z )}}}{{ω}^{2} ( z )} \cdot cos ( {ϕ}_{0} - \frac{4 π}{λ} \cdot ( z + \frac{{x}^{2} + {y}^{2}}{2 \cdot R ( z )} ) + 2 \cdot arctan ( \frac{z}{{Z}_{R}} ) ) \qquad ( 6 )$$

wherein:

x, y and z represent the coordinates of the point in the direct reference frame (O, x,y,z) linked to the backscattered beam whose origin is at the center of the waist of the backscattered beam with Oz merged with the axis of the backscattered beam (m), oriented from the collection optic toward the waist of the backscattered beam, the orientation of axes Ox and Oy is immaterial,

$${d}_{{ω}_{0}} = \sqrt{\frac{{Z}_{R} \cdot λ}{π}}$$

is the radius at 1/e² intensity at the waist of the backscattered Gaussian beam,

$${d}_{ω} ( z ) = {d}_{{ω}_{0}} \cdot \sqrt{1 + {( \frac{z}{{Z}_{R}} )}^{2}}$$

is the radius at 1/e² intensity of the beam at the distance z from the waist

$$R ( z ) = z \cdot ( 1 + {( \frac{{Z}_{R}}{z} )}^{2} )$$

is the radius of curvature of the wavefront at the distance z from the waist

φ₀ is a phase term comprising the phase noise of the laser, the phase of the backscattering and a shift of

$$\frac{π}{2}$$

It is then possible to obtain the contribution to the power spectral density or PSD of the Narcissus ray of the scattering point generating a Narcissus echo under consideration. The mean power (iₕₑₜ²(t)) has a value of:

$$〈 {i}_{het}^{2} ( t ) 〉 = 8 {ρ}^{2} \cdot {P}_{OL} \cdot {P}_{IL} \cdot \frac{{λ}^{2}}{{π}^{2}} \cdot σ \cdot \frac{{e}^{- 4 \frac{{x}^{2} + {y}^{2}}{{ω}^{2} ( z )}}}{{ω}^{4} ( z )} \qquad ( 7 )$$

The generated frequency has a value, developing the expression for R(z), of:

$${f}_{N} = \frac{1}{2 π} \cdot \dot{ϕ} = - \frac{2}{λ} \cdot ( \dot{z} + \frac{x \cdot \dot{x} + y \cdot \dot{y}}{R ( z )} - \frac{( {x}^{2} + {y}^{2} ) \cdot \dot{R} ( z )}{2 \cdot {R}^{2} ( z )} ) + \frac{1}{π} \cdot \frac{{Z}_{R} \cdot \dot{z}}{{Z}_{R}^{2} + {z}^{2}} \qquad ( 8 )$$

The last term of this expression is negligible compared to the first because

$$\frac{λ}{2} << π \cdot \frac{{Z}_{R}^{2} + {z}^{2}}{{Z}_{R}} .$$

The third term of this expression can be expressed taking account of the fact that there cannot be any lighting at long distances from the beam axis, therefore (x²+y²)<A·ω² (z):

$$\frac{{z}^{2} \cdot ( {x}^{2} + {y}^{2} ) \cdot ( 1 - \frac{{z}_{R}^{2}}{{z}^{2}} ) \cdot \dot{z}}{2 \cdot {( {Z}_{R}^{2} + {z}^{2} )}^{2}} < \frac{{z}^{2} \cdot \frac{λ}{π} \cdot A \cdot \frac{{z}_{R}^{2} + {z}^{2}}{{Z}_{R}} \cdot ( 1 - \frac{{Z}_{R}^{2}}{{z}^{2}} ) \cdot \dot{z}}{2 \cdot {( {Z}_{R}^{2} + {z}^{2} )}^{2}} < \frac{λ}{2 π} \cdot \frac{A}{{Z}_{R}} \cdot ( 1 - \frac{{Z}_{R}^{2}}{{z}^{2}} ) \cdot \dot{z} << \dot{z} \qquad ( 9 )$$

This term is therefore also negligible compared to the first. Therefore only the two first terms of this expression will be retained hereinbelow.

The passing of the coordinates from a point in the reference frame having as origin the vertex of the cone O′ (to be represented in the FIGURE), and as O′z′ axis the cone axis, to the reference frame having as origin the center of the waist W of the beam, and as Wz″ axis the beam axis is effected by the following operation:

$$\begin{matrix}( \begin{matrix}x \\ y \\ z\end{matrix} ) = {R}_{z} ( 2 \cdot π \cdot {f}_{r} \cdot t ) \cdot {R}_{y} ( - α ) \cdot {R}_{z} ( - 2 \cdot π \cdot {f}_{r} \cdot t ) \cdot ( \begin{matrix}{x}^{′} \\ {y}^{′} \\ {z}^{′}\end{matrix} ) + ( \begin{matrix}0 \\ 0 \\ - f\end{matrix} ) \\ wherein {R}_{y} ( θ ) = ( \begin{matrix}cos θ & 0 & sin θ \\ 0 & 1 & 0 \\ - sin θ & 0 & cos θ\end{matrix} ) and \\ {R}_{z} ( θ ) = ( \begin{matrix}cos θ & - sin θ & 0 \\ sin θ & cos θ & 0 \\ 0 & 0 & 1\end{matrix} ) or setting \\ θ = 2 \cdot π \cdot {f}_{r} \cdot t & ( 10 ) \\ ( \begin{matrix}x \\ y \\ z\end{matrix} ) = ( \begin{matrix}{sin}^{2} θ + {cos}^{2} θ \cdot cos α & ( cos α - 1 ) \cdot cos θ \cdot sin θ & - cos θ \cdot sin α \\ ( cos α - 1 ) \cdot cos θ \cdot sin θ & {sin}^{2} θ \cdot cos α + {cos}^{2} θ & - sin θ \cdot sin α \\ cos θ \cdot sin α & sin θ \cdot sin α & cos α\end{matrix} ) \cdot ( \begin{matrix}{x}^{′} \\ {y}^{′} \\ {z}^{′}\end{matrix} ) + ( \begin{matrix}0 \\ 0 \\ - f\end{matrix} ) & ( 11 )\end{matrix}$$

The derivatives of the coordinates of the point in the reference frame linked to the beam are thus obtained simply by deriving this expression.

$$( \begin{matrix}\dot{x} \\ \dot{y} \\ \dot{z}\end{matrix} ) = 2 \cdot π \cdot {f}_{r} \cdot ( \begin{matrix}- ( cos α - 1 ) \cdot sin 2 θ & ( cos α - 1 ) \cdot cos 2 θ & sin θ \cdot sin α \\ ( cos α - 1 ) \cdot cos 2 θ & ( cos α - 1 ) \cdot sin 2 θ & - cos θ \cdot sin α \\ - sin θ \cdot sin α & cos θ \cdot sin α & 0\end{matrix} ) \cdot ( \begin{matrix}{x}^{′} \\ {y}^{′} \\ {z}^{′}\end{matrix} ) \qquad ( 12 )$$

This expression shows that the derivatives of the relative position at each coordinate are of the same order of magnitude. It is therefore possible to also neglect the second term in the expression (8) of the generated frequency f_{N} because x<<R(z) and y<<R(z) and the final expression, which is indeed equivalent to the formula (5) found by the simplified analysis, is obtained:

$${F}_{N} = \frac{2}{λ} \cdot 2 \cdot π \cdot {f}_{r} \cdot sin α ( {x}^{′} \cdot sin θ - {y}^{′} \cdot cos θ ) \qquad ( 13 )$$

It will now be considered that the scatterers are distributed uniformly over the faces of the porthole. In this case it is possible to consider that the surface scattering coefficient of the faces as

$$µ = \frac{{\partial }^{2} σ}{\partial x \partial y} .$$

It is then possible to choose the orientation of the axes x and y and the origin of the times so that at the instant t=0 the beam is deviated in the direction of the positive x-direction. The power spectral density generated at the frequency v at the instant t=0 then has a value of:

$$DPS ( v ) = \frac{1}{\frac{\partial v}{\partial {y}^{′}}} {\int }_{- ∞}^{+ ∞} 〈 {i}_{het}^{2} ( t ) 〉 ( {x}^{′} , {y}^{′} = \frac{- λ \cdot v}{4 \cdot π \cdot {f}_{r} \cdot sin α} , {z}^{′} ) \cdot d {x}^{′} \qquad ( 14 )$$

Combining the equations (14), (7) and (9) and by making the approximation that z≈z′·cos α−f gives:

$$\begin{matrix}DPS ( v ) = \frac{{λ}^{3} \cdot {ρ}^{2} \cdot {P}_{OL} \cdot {P}_{IL} \cdot µ \cdot \sqrt{π}}{{π}^{3} \cdot {f}_{r} \cdot sin α \cdot {ω}^{3} ( z ) \cdot cos α} \cdot {e}^{- \frac{{λ}^{2} \cdot {v}^{2}}{4 \cdot {π}^{2} \cdot {f}_{r}^{2} \cdot {sin}^{2} α \cdot {ω}^{2} ( z )}} & ( 15 ) \\ {\int }_{- ∞}^{+ ∞} DPS ( v ) \cdot d v = \frac{2 \cdot {λ}^{2} \cdot {ρ}^{2} \cdot {P}_{OL} \cdot {P}_{IL} \cdot µ}{π \cdot {ω}^{2} ( z ) \cdot cos α} & ( 16 )\end{matrix}$$

The Narcissus ray produced in the present spectrum therefore has a total power described by the preceding equation (16) and a Gaussian shape with the half-width at 1/e2 (or −8.6 dB) equal to

$$Δ v = \frac{\sqrt{2} \cdot 2 \cdot π \cdot {f}_{r} \cdot sin α \cdot ω ( z )}{λ} \qquad ( 17 )$$

Or, applying the digital values proposed at the beginning of this chapter, Δv=131 kHz.

What is claimed is:

1. A device for determining the presence of damage or dirt on a Doppler laser anemometry probe (2) porthole (1) comprising means (6) for implementing a continuous angular scan of the laser beam, means (7) for determining a current spectral component of the output signal of the probe (2) corresponding to a parasitic signal due to parasitic reflections on the path common to the emitted wave and the wave backscattered by the medium during spectral analysis of the anemometric signal, and means (8) for comparing said current spectral component of the current parasitic signal with a reference spectral component of the reference parasitic signal.

2. An aircraft equipped with a device for determining the presence of damage or dirt on a Doppler laser anemometry probe (2) porthole (1) embedded on said aircraft, as claimed in claim 1.

3. The device as claimed in claim 1, wherein said threshold is between 0.5 dB and 20 dB.

4. An aircraft equipped with a device for determining the presence of damage or dirt on a Doppler laser anemometry probe (2) porthole (1) embedded on said aircraft, as claimed in claim 3.

5. The device as claimed in claim 1, wherein said threshold is between 3 dB and 5 dB.

6. An aircraft equipped with a device for determining the presence of damage or dirt on a Doppler laser anemometry probe (2) porthole (1) embedded on said aircraft, as claimed in claim 5.

7. The device as claimed in claim 1, wherein said comparing means (8) are suitable for computing the absolute value of the difference between the amplitude of said current component and the amplitude of said reference component and for comparing said difference with a threshold.

8. An aircraft equipped with a device for determining the presence of damage or dirt on a Doppler laser anemometry probe (2) porthole (1) embedded on said aircraft, as claimed in claim 7.

9. The device as claimed in claim 7, wherein said threshold is between 0.5 dB and 20 dB.

10. An aircraft equipped with a device for determining the presence of damage or dirt on a Doppler laser anemometry probe (2) porthole (1) embedded on said aircraft, as claimed in claim 9.

11. The device as claimed in claim 7, wherein said threshold is between 3 dB and 5 dB.

12. An aircraft equipped with a device for determining the presence of damage or dirt on a Doppler laser anemometry probe (2) porthole (1) embedded on said aircraft, as claimed in claim 11.

13. A method for determining the presence of damage or dirt on a Doppler laser anemometry probe (2) porthole (1) comprising the steps consisting in carrying out (6) a continuous angular scan of the laser beam, determining (7) a current spectral component of the output signal of the probe (2) corresponding to a parasitic signal due to parasitic reflections on the path common to the emitted wave and the wave backscattered by the medium during spectral analysis of the anemometric signal, and comparing (8) said current spectral component of the current parasitic signal with a reference spectral component of the reference parasitic signal.
